(19) United States
(12) Patent Application Publication
(10) Pub. No.: US 2009/0298002 A1
(43) Pub. Date: Dec. 3, 2009

(54) INDIRECT HEAT EXCHANGER

(76) Inventors: Gabriel Constantin, Buc (FR); Rémi Pierre Tsiava, Saint Germain-Les-Corbeil (FR); Bertrand Leroux, Issy-Les-Moulineaux (FR)

Correspondence Address: AIR LIQUIDE;Intellectual Property, 2700 POST OAK BOULEVARD, SUITE 1800, HOUSTON, TX, 77056, US

(21) Appl. No.: 11/719,823

(22) PCT Filed: Nov. 14, 2005
(86) PCT No.: PCT/FR05/50943

§ 371 Date: May 11, 2009

(30) Foreign Application Priority Data
Nov. 22, 2004 (FR) 0452714

(51) Int. Cl. F23L 15/00; F27D 7/00; F28D 15/00

(52) U.S. Cl. 432/29; 432/199; 165/104.34

(57) ABSTRACT

The invention concerns a heat exchanger (4) for a combustion oven, said exchanger comprising a heat exchanging zone (2) provided with means for the passage of hot fumes derived from a burner of the oven, said zone being traversed by at least one means (1a) for transporting a combustion gas to be heated from a combustion gas source, via the heat exchanging zone and to the oven burner, said means (1a) being provided with a wall (1b) designed to enable the combustion gas to be heated by thermal energy transfer, said means (1a) for transporting the combustion gas being arranged in the heat exchanging zone in means (3a) capable of containing an inert gas and provided with a wall (3b) designed to enable the inert gas to be heated by thermal energy transfer of said hot fumes.

The invention relates to the entire industry in which use is made of a furnace generating hot flue gases, in which furnace the heat energy of the hot flue gases is to be used to preheat reagents supplied to the furnace, and thereby improve the heat efficiency of the furnace. It may be related in particular to the glass industry, and particularly the plate glass industry.

Two methods for heating gas using hot flue gases are essentially known.

Firstly, devices are known comprising a heat exchanger for directly, optionally through a wall, heating the combustion gas by the hot flue gases generated by the furnace. Documents EP 950 031 and U.S. Pat. No. 5,807,418 describe such devices. This solution, although having a reasonable cost since it only comprises a single heat exchanger, nevertheless does not appear to provide a reliable or in any case sufficient level of safety. In fact, the flue gases often contain unburnts, either because the process requires a reducing atmosphere, or because of faulty operation of the burner. Over time, the heat exchanger material may be damaged, particularly by corrosion, due to the contact with the hot flue gases. Defective parts of the heat exchanger may then allow contact of the hot combustion gas, which is assumed to be oxygen, with these unburnts, and thereby generate a source of fire whereof the consequences would be disastrous.

Furthermore, devices are also known comprising a two-step heat exchange, using two distinct heat exchangers. The first heat exchanger serves to heat an intermediate fluid, particularly air, using the hot flue gases, and the second heat exchanger serves to heat the combustion gas, in particular oxygen, using the intermediate fluid previously heated by the first heat exchanger. Documents U.S. Pat. No. 6,071,116 and U.S. Pat. No. 6,250,916, patents to the proprietor of the present patent application, describe such devices. This solution is safer than the first one described above, because the oxygen content of the intermediate fluid is insufficient to ignite the unburnts in the flue gases. Moreover, a perforation of the combustion gas/intermediate fluid heat exchanger walls will have no effect when said gas is oxygen and the intermediate fluid is air, because it involves the contact of two oxidizers. By contrast, this solution is unsuitable for heating natural gas as combustion gas, because a defect in the intermediate fluid/gas heat exchanger would permit the mixing of natural gas with hot air (intermediate fluid) and would generate an explosion. Another disadvantage of this solution is its high cost, because it requires two distinct heat exchangers connected by a circuit.

Thus a need subsists for an improved heat exchange device, serving to avoid the drawbacks of the known devices.

The subject of the invention is therefore a heat exchanger for a combustion furnace, said heat exchanger comprising a heat exchange zone provided with a means for the passage of hot flue gases issuing from a burner of the furnace, said zone being traversed by at least one means for transporting a combustion gas to be heated from a combustion gas source, via the heat exchange zone and up to a burner of the furnace, said means being provided with a wall designed to enable the combustion gas to be heated by heat transfer, said means for transporting the combustion gas being placed in the heat exchange zone in a means for containing an inert gas and provided with a wall designed to enable the inert gas to be heated by heat transfer from said hot flue gases.

Thus, in a heat exchanger of the invention, the heat transfer or heat exchange between the hot flue gases and the combustion gas occurs indirectly: across a wall (that of the means for transporting a combustion gas) and through an inert gas atmosphere.

In the context of the present invention, combustion gas means any gas commonly used in a heat exchanger, and in particular an oxidizer such as oxygen, air, oxygen-enriched air, or a fuel, such as natural gas.

In the context of the present invention, inert gas means any gas inert to combustion, that is, all incombustible gases except oxygen. Mention can be made in particular of argon, helium, neon, krypton, nitrogen or a mixture thereof. Said inert gas is preferably static. In one embodiment, the inert gas is not static, that is, inert gas flows in the means containing the inert gas, but this implies a separate feed circuit and hence a more complex device.

The means for the passage of hot flue gases issuing from a burner of the furnace may be any means commonly known and used by a person skilled in the art in a usual heat exchanger, in particular the flue gases may be channeled in countercurrent flow to the combustion gas or perpendicular to the direction of the combustion gas.

The means for transporting the combustion gas may be any appropriate means known to a person skilled in the art and permitting the transport of the combustion gas from a combustion gas source, via the heat exchange zone, and toward a burner of the combustion furnace. It may, for example, be at least one tube or duct; straight or not. The cross section of said means may be any cross section, regular or not, for example perfectly or substantially circular, or oval or elliptical or rectangular, or rectangular with rounded angles or any intermediate form, and is preferably perfectly or substantially circular. Any means for transporting a combustion gas used in a heat exchanger of the prior art may be used.

The wall of the means for transporting the combustion gas is mainly made from an appropriate material for resisting a hot combustion gas atmosphere, and appropriate for permitting heat exchange between the combustion gas and the inert gas, which has itself been heated by the hot flue gases passing though the heat exchange zone. The material mainly used is therefore preferably resistant to oxidation in a hot oxygen atmosphere, when the combustion gas is an oxidizer containing oxygen. The materials suitable for use preferably develop a protective coat of metal oxide (passivation mechanism) in the hot oxygen. The types of materials usable are particularly iron-nickel alloys, and particularly the alloy Fe-20Cr-30Ni. For certain applications, it is desirable for the material used to contain no nickel, in which case materials such as the alloy Fe-21Cr-5A1 can be used, less readily available and more expensive. In general, since the wall is not in direct contact with the hot flue gases, the constraints in terms of choice of material are lesser than in the heat exchangers of the prior art, in which the constraints are related not only to the contact with the hot combustion gas but also to the contact with the hot flue gases.

By way of example, the effective flue gas temperature may vary between 500° C. and 1600° C., whereas the temperature of the walls in contact with the hot flue gases may vary from 300° C. to 1300° C. and that of the walls in contact with the combustion gas to be heated may vary from 300° C. to 1000° C.; the inert gas temperature may vary from 300° C. to 1000° C. and that of the combustion gas from 300° C. to 1000° C.

The means for containing an inert gas may be any appropriate means for containing an inert gas, static or not, and in which at least one means can be placed for transporting a combustion gas. It may, for example, be at least one tube or duct, straight or not. The cross section of said means may be any cross section, regular or not, for example perfectly or substantially circular, or oval or elliptical or rectangular, or rectangular with rounded angles or any intermediate form. The cross section of said means for containing an inert gas should be of larger dimensions but preferably similar or identical in shape to the cross section of the means for transporting the combustion gas, in particular when a single means for transporting a combustion gas is placed in the means for containing an inert gas.

A person skilled in the art will understand that the thickness, uniform or not, of the inert gas atmosphere in which the means for transporting a combustion gas is placed, must not be too high, so that the heat transfer can occur from the hot flue gases to the inert gas and up to the combustion gas, and will know how to determine the maximum appropriate thickness.

The heat transfer between the hot flue gases and the combustion gas via the inert gas also depends on the pressure of the inert gas, because at high pressure, the density of the inert gas increases and hence the heat transfer rate increases, and the heat exchanger is therefore basically more efficient.

In a first particular embodiment, the means for transporting the combustion gas and the means for containing the inert gas are straight tubes with a perfectly or substantially circular cross section. There is normally no direct contact between the combustion gas and the wall of the means for containing the inert gas. Said wall therefore does not undergo the same stresses as that of the means for transporting the combustion gas, and the probability of corrosion and/or oxidation is much lower. Thus the range of usable materials is broader than that of the materials usable for the wall of the means for transporting a combustion gas.

In a second particular embodiment, the means for transporting the combustion gas and the means for containing the inert gas are straight tubes with a perfectly or substantially circular cross section and, furthermore, these tubes are connected together by metal bridges extending from the inside wall of the outer tube to the outer wall of the inner tube. This second embodiment has the advantage of permitting heat transfer by radiation due to the conduction across these metal bridges. It also has the advantage of reinforcing the mechanical properties of the heat exchanger.

In one embodiment, the means for transporting a combustion gas is placed in a means for containing an inert gas only in the heat exchange zone. In another embodiment, it is placed in a means for containing an inert gas in the heat exchange zone and in one or more zones preceding and/or following said heat exchange zone in the combustion gas transport direction in the means for transporting the combustion gas, said transport direction being from the inlet of the combustion gas in said means to the outlet of the combustion gas from said means.

A heat exchanger of the invention may comprise a single means for transporting a combustion gas, placed in a single means for containing an inert gas. In this embodiment, each set of means for transporting a combustion gas/means for containing an inert gas may be inserted and removed individually in case of damage.

A heat exchanger of the invention may also comprise a plurality of means for transporting a combustion gas—for example ten of said means—each of said means being placed in a means for containing an inert gas. In this embodiment, each set of means for transporting a combustion gas/means for containing an inert gas may also be inserted and removed individually in case of damage. In this embodiment, the means for containing an inert gas may optionally be connected together in the heat exchange zone by appropriate ducts, in which case, in case of damage, it would be necessary to replace all the sets of means for transporting a combustion gas/means for containing an inert gas.

A heat exchanger of the invention may further comprise a plurality of means for transporting a combustion gas placed in a single means for containing an inert gas. In this embodiment, the set of means for transporting a combustion gas/means for containing an inert gas must be inserted and removed in case of damage.

Preferably, when a heat exchanger of the invention comprises a plurality of means for transporting a combustion gas, the placing in the same heat exchanger of a means for transporting an oxidizer and a means for transporting a fuel is avoided, and a means for transporting a combustion gas of the same type (oxidizer or fuel) is rather placed in the same heat exchanger.

The heat exchange zone of the heat exchanger of the invention is suitable for being traversed by hot gases issuing from a burner of the furnace. In practice, the hot flue gases leave the burner and are recovered in a pipe, which conveys them to the heat exchanger, so that they pass through it as desired. The direction of passage of the hot flue gases may be any direction, for example from the bottom upward, or countercurrent to the transport direction of the combustion gas, as known to a person skilled in the art.

The indirect heat exchanger of the invention has several advantages due to the presence of an inert gas zone.

The indirect heat exchanger of the invention serves to broaden the range of usable materials. In fact, during the starting of the heat exchanger, the means for containing an inert gas undergoes a sudden and wide variation in temperature, for example of about 1300° C. (temperature of the wall which may be reached after contact with the hot flue gases), but there is no risk of corrosion or oxidation of its wall because there is no direct contact between the combustion gas (which may be oxygen or may contain oxygen) and the wall of said means for containing the inert gas. On the contrary, the means for transporting the combustion gas is more sensitive to sudden variations in temperature because they accelerate the corrosion and oxidation thereof; by contrast, it undergoes a slower variation in temperature because the heat transfer takes place through the inert gas which operates as a buffer.

Furthermore, during the operation of a heat exchanger, the temperature of the hot flue gases may vary locally. In a heat exchanger of the prior art, this gives rise to variations in temperature of the combustion gas which is heated, variations which must be taken into account in controlling combustion. In the case of a heat exchanger of the invention, the thermal inertia of the inert gas decreases the scale of these variations.

Moreover, the presence of said inert gas zone has advantageous consequences in terms of safety. In fact, in case of perforation of the wall or ignition of the means for transporting the combustion gas, the mixing of the combustion gas with the hot flue gases is prevented because of the inert gas. Moreover, the inert gas may be absorbed by Venturi effect in said means for transporting the combustion gas, and the lower purity of the often oxidizing combustion gas serves to reduce the probability of propagation of combustion.

In one embodiment, the heat exchanger of the invention is equipped with a means for controlling the operation of the heat exchanger, which is suitable for detecting defects.

In particular, the means for containing an inert gas may be connected to a detector of a variation in pressure. If the pressure variation detector detects a drop in pressure, this is identified as a leak of inert gas due to a perforation of a wall. A safety alarm can then be tripped and a bypass system may be provided to continue supplying the burner with combustion gas while stopping the passage of the hot flue gases in the damaged heat exchanger which can be repaired.

The means for containing an inert gas may also be connected to a means for controlling the operation of the heat exchanger which measures the inert gas temperature and pressure at all times. This double detection serves to refine the control. In fact, the inert gas temperature varies considerably during startup (for example from about 30° C. to about 1000° C.), unless it is previously heated, and this temperature variation causes a variation in pressure at constant volume. In a system which only controls the pressure, the pressure variation during startup can generate false-positive alarms. On the contrary, in a system controlling the temperature and the pressure, the control can be more accurate and an alarm can be provided, that is, the sign of a leakage of inert gas, in the following cases: (1) the measured pressure decreases and the measured temperature remains constant, or (2) the measured pressure decreases and the measured temperature increases. A bypass system may be provided to continue supplying the burner with combustion gas while stopping the passage of the hot flue gases in the damaged heat exchanger which can be repaired.

The drop in pressure, detected by a pressure detector or a pressure and temperature detector, may reveal a leak of inert gas due to a perforation of the wall of the means for transporting a combustion gas and/or of the wall of the means for containing an inert gas, even if these walls are not subjected to the same stresses.

In the case of a heat exchanger comprising a means for controlling the operation of the heat exchanger, it is preferable for a pressure difference ΔP to exist between the static pressure of the combustion gas P_{GC static} and the static pressure of the inert gas P_{GI static}, this pressure difference being positive or negative. Preferably, the pressure difference is positive, that is, the static pressure of the inert gas is higher than the static pressure of the combustion gas. A pressure difference higher than the background noise of the instrument, that is, than the normal variations, is preferred in order to limit the false-positive alarms. A person skilled in the art can determine the background noise of a device on an individual case basis, after measuring the pressure variation of the device.

In general, and whether or not a pressure difference ΔP exists, the heat transfer between the hot flue gases and the combustion gas via the inert gas also depends on the pressure of the inert gas, because at high pressure, the density of the inert gas increases and hence the heat transfer rate increases, the heat exchanger is therefore basically more efficient.

Moreover, a positive pressure difference, that is, P_{GI static}>P_{GC static}, favors the leakage of inert gas in the means for transporting a combustion gas, and therefore favors the Venturi effect, in case of wall perforation or ignition of the means for transporting the combustion gas, and particularly favors the stopping of the ignition because of the inert gas stream. In general, it is easy for a person skilled in the art to determine the appropriate inert gas pressure: knowing the inlet flow rate and diameter of the means for transporting the combustion gas, the static pressure can be determined, and consequently the desired inert gas pressure can be set to obtain a pressure difference or not, positive or not. For information, the heat exchanger can be dimensioned, and more specifically the inert gas pressure, so that in case of incipient combustion (during a leak), the inert gas flow rate aspirated by Venturi effect into the means for transporting a combustion gas is higher, preferably about two times higher, preferably even about four times higher, than the flow rate of the combustion gas. When the combustion gas is oxygen, and the inert gas flow rate is about four times higher than that of the oxygen, the percentage of oxygen in the mixture formed due to aspiration by Venturi effect is then equivalent to the percentage of oxygen in the air. This calculation can be made on the basis of an estimation of the size of the perforation in the means for containing the combustion gas. Furthermore, since the combustion gas flow rate may be variable, the calculation is preferably carried out on the basis of the maximum flow rate (and hence of the corresponding pressure) of combustion gas which can be applied in the heat exchanger. If the size of the perforation in the means for containing the combustion gas is smaller than the size provided for the dimensioning calculation, and in consequence the inert gas pressure applied does not make it possible to stop the combustion of the material, the presence of a detector of a variation in pressure of the inert gas serves to stop the supply of combustion gas and to obtain the combustion of the material rapidly.

A further subject of the invention is a combustion furnace comprising at least one heat exchanger of the invention. Preferably, it comprises a plurality of heat exchangers of the invention, one or more for supplying the furnace with fuel and/or one or more for supplying the furnace with oxidizer.

A further subject of the invention is a heat exchange method for preheating a combustion gas fed to a combustion furnace emitting hot flue gases, said method comprising a step of preheating of the combustion gas by heat exchange with the hot flue gases, via an inert gas atmosphere. The inventive method may comprise the use of a heat exchanger of the invention.

The indirect heat exchanger of the invention is described in greater detail in conjunction with the figures appended hereto, provided exclusively for illustration, and in which:

FIG. 1 shows one embodiment of an indirect heat exchanger of the invention,

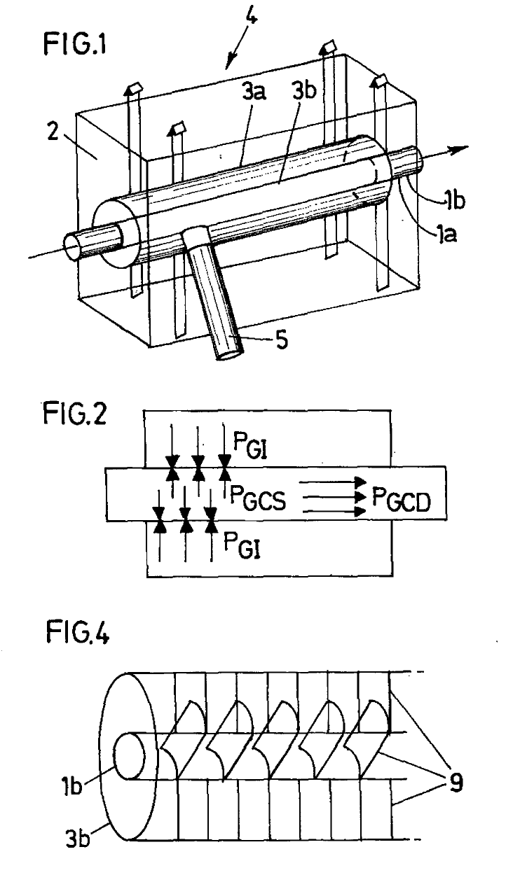

FIG. 2 shows the inert gas and combustion gas pressures in a heat exchanger of the invention,

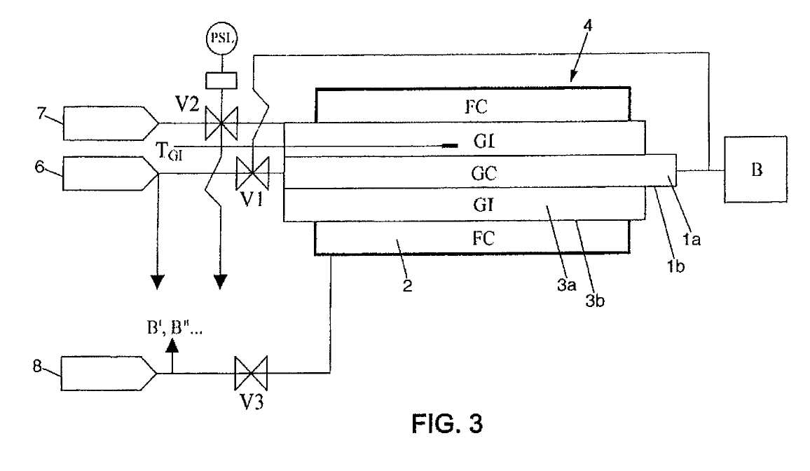

FIG. 3 shows an indirect heat exchanger of the invention in a feed system of a combustion furnace,

FIG. 4 shows a particular type of heat exchanger of the invention.

FIG. 1 shows an indirect heat exchanger (4) of the invention comprising a heat exchange zone (2), traversed by hot flue gases, and comprising a means (1a) for transporting a combustion gas in the direction indicated by the arrows, said means being equipped with a wall (1b), placed in a means (3a) for containing an inert gas provided with a wall (3b). In this embodiment, the means (1a) for transporting a combustion gas is placed in the means (3a) for containing an inert gas in the heat exchange zone (2) and in the zones preceding and following said heat exchange zone in the combustion gas flow direction in the means for transporting the combustion gas.

The means for controlling the operation of the heat exchanger (5), which is optional, is shown here connected to the means for containing an inert gas. The wide vertical arrows indicate the flow direction of the hot flue gases, on either side of the means (1a) and (3a), which in this embodiment is perpendicular to the combustion gas flow direction.

FIG. 2 shows the inert gas pressure P_{GI} and the combustion gas pressure P_{GC}, static P_{GC S}, or dynamic P_{GC D}, in a heat exchanger of the invention. It is preferable for P_{GI static} to be higher than P_{GC static}, in order to create a positive pressure difference ΔP=P_{GI static}−P_{GC static}.

FIG. 3 shows the diagram of an overall feed device of a combustion furnace and more specifically of a burner (B) of said furnace. The device comprises a heat exchanger of the invention. The heat exchanger is connected to a combustion gas source (6), to an inert gas source (7) and to a source of hot flue gases (8). The heat exchanger comprises a heat exchange zone (2), traversed by hot flue gases (passage direction not shown). It also comprises a means (1a) for transporting a combustion gas GC equipped with a wall (lb), feeding a burner (B), said means (1a) being placed in a means (3a) for containing an inert gas GI provided with a wall (3b). In this embodiment, the means (1a) for transporting a combustion gas GC is placed in the means (3a) for containing an inert gas GI in the heat exchange zone (2) and in the zones preceding and following said heat exchange zone in the combustion gas transport direction in the means for transporting the combustion gas. Three valves V1, V2 and V3 are present for controlling the feeds of combustion gas (valve V1), inert gas (valve V2) and hot flue gases (valve V3), respectively. The heat exchanger shown comprises a means for controlling the operation of the heat exchanger connected to the means for containing an inert gas, and to the valves. This means for controlling the operation of the heat exchanger comprises a temperature detector T_{GI} and a pressure detector PSL for measuring the inert gas temperature and pressure.

A perforation is detected by the means for controlling the operation of the heat exchanger if the detector T_{GI} measures a drop in pressure and a constant temperature, or if the detector T_{GI} measures a drop in pressure and an increase in temperature. The valve V1 is adjusted so that the combustion gas avoids the damaged heat exchanger via a bypass, the valve V3 is adjusted to stop the passage of the flue gases into the damaged heat exchanger, a safety alarm is tripped, and the damaged components can be replaced. The sources of combustion gas (6), inert gas (7) and hot flue gases (8) can then optionally feed or continue to feed other burners B′, B″, etc.

FIG. 4 shows the diagram of a heat exchanger of the invention consisting of two straight cross section tubes whereof the walls (1b) and (3b) are connected together by metal bridges (9) extending from the inside wall of the outer tube to the outer wall of the inner tube.

1-15. (canceled)

16. A heat exchange method for preheating a combustion gas fed to a combustion furnace emitting hot flue gases, said method comprising a step for preheating the combustion gas by heat exchange with the hot flue gases, via an inert gas atmosphere.

17. The method of claim 16, comprising the use of a heat exchanger comprising a heat exchange zone provided with a means for the passage of hot flue gases issuing from a burner of the furnace, said zone being traversed by at least one means for transporting a combustion gas to be heated from a combustion gas source, via the heat exchange zone and up to a burner of the furnace, said means being provided with a wall designed to enable the combustion gas to be heated by heat transfer, said means for transporting the combustion gas being placed in the heat exchange zone in a means for containing the inert gas and provided with a wall designed to enable the inert gas to be heated by heat transfer from said hot flue gases.

18. The method of claim 17, wherein the inert gas is static.

19. The method of claim 17, wherein the means for transporting the combustion gas is a tube or duct, in particular having a perfectly or substantially circular cross section.

20. The method of claim 17, wherein the means (3a) for containing the inert gas is a tube or duct, in particular having a perfectly or substantially circular cross section.

21. The method of claim 17, wherein the means for transporting the combustion gas is placed in the means for containing the inert gas in the heat exchange zone and in one or more zones preceding and/or following said heat exchange zone in the combustion gas transport direction in the means for transporting the combustion gas.

22. The method of claim 17, wherein it comprises a plurality of means for transporting the combustion gas.

23. The method of claim 22, wherein the heat exchanger comprises a plurality of means for containing the inert gas, and in that each of the means for transporting the combustion gas is placed in one of the means for containing the inert gas, said means for containing the inert gas being optionally connected together by ducts in the heat exchange zone.

24. The method of claim 17, wherein the operation of the heat exchanger is controlled by a control means, particularly a means for controlling the operation of the heat exchanger connected to the means for containing the inert gas.

25. The method of claim 24, wherein the means for controlling the operation of the heat exchanger detects variations in pressure or variations in pressure and temperature.

26. The method of claim 17, wherein it has a pressure difference, in particular positive, between the static pressure of the combustion gas and the static pressure of the inert gas.

27. A combustion furnace comprising at least one burner and at least one heat exchanger comprising a heat exchange zone provided with a means for the passage of hot flue gases issuing from a burner of the furnace, said zone being traversed by at least one means for transporting a combustion gas to be heated from a combustion gas source, via the heat exchange zone and up to a burner of the furnace, said means being provided with a wall designed to enable the combustion gas to be heated by heat transfer, said means for transporting the combustion gas being placed in the heat exchange zone in a means for containing an inert gas and provided with a wall designed to enable the inert gas to be heated by heat transfer from said hot flue gases.

28. The furnace of claim 27, wherein the heat exchanger comprises a plurality of means for transporting a combustion gas.

29. The furnace of claim 28, wherein the heat exchanger comprises a plurality of means for containing an inert gas, and in that each of the means for transporting a combustion gas is placed in one of the means for containing an inert gas, said means for containing an inert gas being optionally connected together by ducts in the heat exchange zone.

30. The furnace of claim 17, wherein the heat exchanger comprises a means for controlling the operation of the heat exchanger, particularly a means for controlling the operation of the heat exchanger connected to the means for containing an inert gas.
